(19) United States
(12) Patent Application Publication
(10) Pub. No.: US 2016/0216988 A1
(43) Pub. Date: Jul. 28, 2016

(54) EXPOSING STORAGE ENTITY CONSISTENCY CAPABILITY STATUS

(71) Applicant: Microsoft Technology Licensing, LLC, Redmond, WA (US)

(72) Inventors: Jacob Oshins, Seattle, WA (US); James Patrick Lang, Issaquah, WA (US)

(21) Appl. No.: 14/607,963

(22) Filed: Jan. 28, 2015

(51) Int. Cl. G06F 9/455; G06F 17/30; G06F 9/48

(52) U.S. Cl. CPC G06F 9/45558; G06F 9/4856; G06F 17/30371; G06F 2009/45583

(57) ABSTRACT

A storage entity (e.g., a virtual hard drive) that exposes its technical capabilities including a consistency capability status via an application program interface to a software module (e.g., a virtual machine). The storage entity queries the storage entity through an application program interface to determine technical capabilities of the storage entity. The storage entity responds with a consistency capability status providing a level of consistency that the storage entity is able to provide data stored thereon. The software module may then use this consistency capability status to determine whether to store which data on the storage entity.

### BACKGROUND

Computing systems and associated networks have revolutionized the way human beings work, play, and communicate. Computing systems are made functional through their ability to process, retrieve, and store information. Conventionally, processing and storage capabilities have been provided on the local computing system itself. However, more recently, for many computing systems, more and more processing and storage capability has been provided outside of the local computing system, perhaps on another node in a network.

More recently, cloud computing environments have been established in which processing and storage of a local computing system can be performed by one or more remote data centers. Often a single remote computing system (referred to as a “host”) is capable of performing such processing and/or storage for many physical computing systems. One way to do this is by assigning an application called a “virtual machine” to each served computing system.

The virtual machine emulates the collective applications and operation system of a computing system. A hypervisor provides hardware services to the virtual machines by providing the appearance of processor, hard drive, and other hardware to each virtual machine, abstracting away from the virtual machine's view the actual physical hardware used to provide this appearance. The hypervisor also provides security between each virtual machine as appropriate to thereby honor the boundaries of data ownership between each virtual machine. In order to provide availability guarantees and preservation of data, the virtual storage entity also provides a high level of consistency, often having duplicate data backed up in multiple locations in case of failure.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the configuration of a software module (e.g., a virtual machine) to interact via an application program interface to storage entities (e.g., a virtual drive) having various consistency capability statuses. The software module is coupled via the application program interface with a first set of one or more storage entities having a first consistency capability status. Furthermore, the software module is configured to discover the first consistency capability status via the application program interface. The software module is further coupled via the application program interface with a second set of one or more storage entities having a second consistency capability status that is different than the first consistency capability status. The software module is further configured to discover the second consistency capability status via the application program interface. The software module thus has available for use storage entities having diverse consistency capability. The software module further has a decision module that considers consistency capability status in deciding which data to store on storage entities.

At least some embodiments described herein relate to a storage entity (e.g., a virtual hard drive) that exposes its technical capabilities including a consistency capability status via an application program interface to a software module (e.g., a virtual machine). The storage entity queries the storage entity through the application program interface to determine technical capabilities of the storage entity. The storage entity responds with a consistency capability status representing a level of consistency that the storage entity is able to provide data stored thereon. The software module may then use this consistency capability status to determine whether to store data (and which data to store) on the storage entity. At least some embodiments described herein relate to a mechanism for configuring the storage entities to have the respective consistency capability statuses.

In this manner, a given software module may store data on a most appropriate storage entity. In some cases, a software module may sacrifice some level of consistency capability of the storage entity in exchange for other desired benefits of that storage entity, such as reduced latency. Accordingly, the data stored in that storage device may be lost upon the physical system crashing. However, this drawback is tempered because the data stored therein may be less sensitive to loss because the decision module has chosen to place only such less sensitive data onto such a storage entity. On the other hand, this drawback comes with the technical benefit that latency when working with such data is reduced in the usual circumstance where there is no physical crash of the system.

In addition, since higher consistency storage entities often provide consistency by archiving, the principles described herein have the potential of reducing the amount of data being archived. After all, data that is less sensitive to consistency may be placed in a storage entity that is not archived at all. This preserves storage, processing, and network bandwidth resources associated with archiving.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 abstractly illustrates an environment in which a software module and various storage entities may communicate via an application program interface regarding consistency storage statuses of the various storage entities in accordance with the principles described herein;

FIG. 3 illustrates a flowchart of a method for configuring a software module to have access to storage entities having various consistency capability statuses;

FIG. 4 illustrates a flowchart of a method for enabling a storage entity to expose technical capabilities of the storage entity;

FIG. 5 illustrates a flowchart of a method for the software entity to store data in the storage entity; and

FIG. 6 illustrates a specific example environment that represents an example of the environment of FIG. 2, but in which the software module is specifically a virtual machine, and in which the storage entities are specifically virtual disks.

### DETAILED DESCRIPTION

At least some embodiments described herein relate to the configuration of a software module (e.g., a virtual machine) to interact via an application program interface to storage entities (e.g., a virtual drive) having various consistency capability statuses. The software module is coupled via the application program interface with a first set of one or more storage entities having a first consistency capability status. Furthermore, the software module is configured to discover the first consistency capability status via the application program interface. The software module is further coupled via the application program interface with a second set of one or more storage entities having a second consistency capability status that is different than the first consistency capability status. The software module is further configured to discover the second consistency capability status via the application program interface. The software module thus has available for use storage entities having diverse consistency capability. The software module further has a decision module that considers consistency capability status in deciding which data to store on storage entities.

At least some embodiments described herein relate to a storage entity (e.g., a virtual hard drive) that exposes its technical capabilities including a consistency capability status via an application program interface to a software module (e.g., a virtual machine). The storage entity queries the storage entity through the application program interface to determine technical capabilities of the storage entity. The storage entity responds with a consistency capability status representing a level of consistency that the storage entity is able to provide data stored thereon. The software module may then use this consistency capability status to determine whether to store data (and which data to store) on the storage entity. At least some embodiments described herein relate to a mechanism for configuring the storage entities to have the respective consistency capability statuses.

In this manner, a given software module may store data on a most appropriate storage entity. In some cases, a software module may sacrifice some level of consistency capability of the storage entity in exchange for other desired benefits of that storage entity, such as reduced latency. Accordingly, the data stored in that storage device may be lost upon the physical system crashing. However, this drawback is tempered because the data stored therein may be less sensitive to loss because the decision module has chosen to place only such less sensitive data onto such a storage entity. On the other hand, this drawback comes with the technical benefit that latency when working with such data is reduced in the usual circumstance where there is no physical crash of the system.

In addition, since higher consistency storage entities often provide consistency by archiving, the principles described herein have the potential of reducing the amount of data being archived. After all, data that is less sensitive to consistency may be placed in a storage entity that is not archived at all. This preserves storage, processing, and network bandwidth resources associated with archiving.

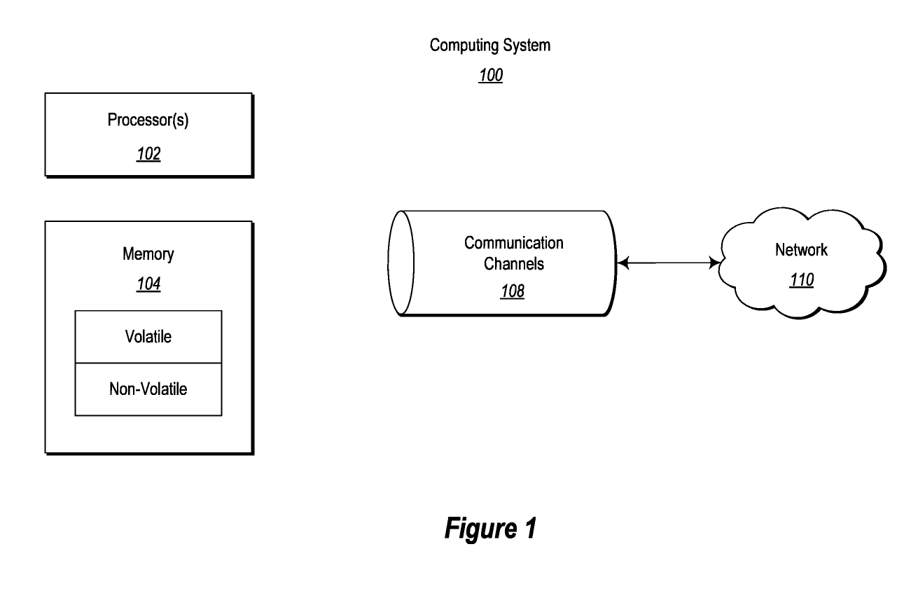

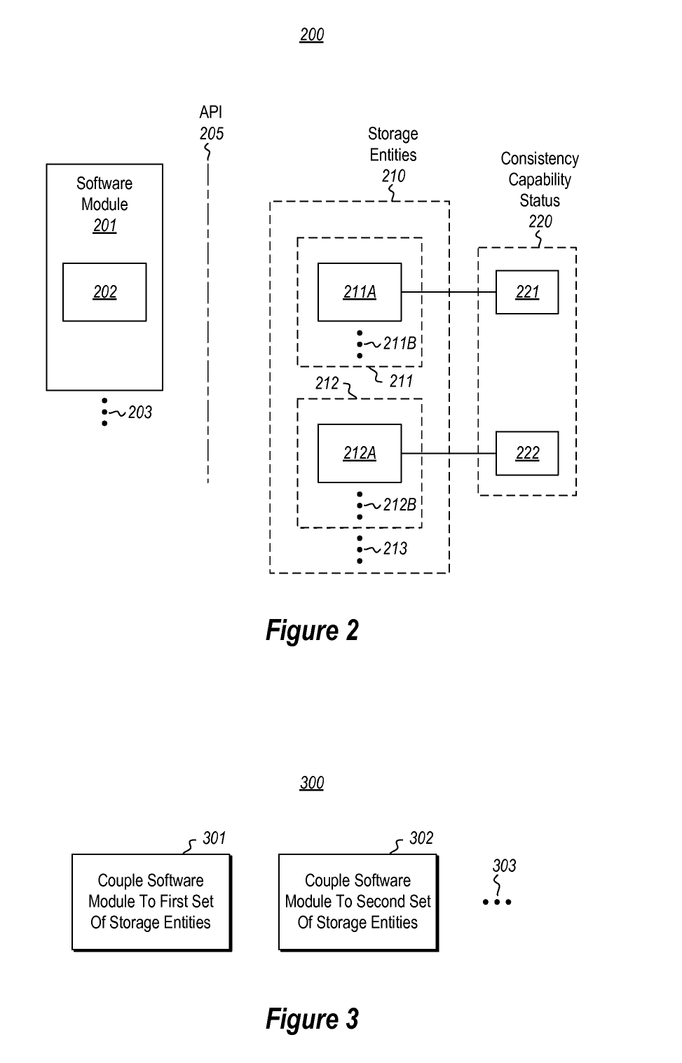

Some introductory discussion of a computing system will be described with respect to FIG. 1. Then, the structure and operation of embodiments described herein will be presented with respect to FIGS. 2 through 6.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors (of the associated computing system that performs the act) direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other computing systems over, for example, network 110.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage entities, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

FIG. 2 abstractly illustrates an environment 200 in which the principles described herein may be employed. In the environment 200, a software module 201 and various storage entities 210 may communicate via an application program interface 205 regarding consistency storage statuses 220 of the various storage entities 210. Furthermore, the software module 201 has a decision module 202 that considers the consistency capability status in deciding which data to store on storage entities.

The environment 200 may be implemented by, for instance, the computing system 100 of FIG. 1. The software module 201 may be an application or other software entity that stores and/or retrieves data to and/or from one or more of the respective storage entities 210. Each of the storage entities 210 may be block-based storage, file-based storage, a database, blob storage, or the like.

The consistency capability status represents an ability for the corresponding storage entity to provide consistent data as it existed at a particular point in time. For instance, at a particular point in time, the storage entity may have a particular collection of data structures that reference each other in a particular way. If the system guarantees consistency at that point in time, then regardless of a system crash the storage entity may be returned to that state with the same data structures and the same relationships between data structures. One way to ensure consistency for all points in time is to snapshot the storage at a particular instant in time, and then copy all write, create or delete operations to a remote backup storage. That way, recovery to any point of time after the snapshot is possible by recovering the snapshot, and replaying the write, create or delete operations that were made up to that point in time. In the case of the storage being transaction-enabled, the storage entity may also track abort and commit operations, and disregard recorded operations for transactions that were not committed.

Conventionally, virtual drives provide a high level of consistency. Such often requires higher latency writes to remote storage, and often prevents the effective utilization of lower latency local storage (such as flash solid state memory/storage), which does not typically provide consistency guarantees. However, in accordance with the principles described herein, for data that is less sensitive to consistency, the software module may be satisfied to write the data with no consistency. In case of a storage entity failure, the data is just understood to be lost.

Between the two extremes of full consistency and no consistency, there is a wide variety of other levels of partial consistency. For instance, the storage may be able to provide a guaranty of consistency for data that was written a predetermined time ago. Thus, the guaranty here is that the data will be eventually consistent (e.g., after 5 minutes).

The storage entity may be able to guaranty a different level of consistency for data written to a certain address space as compared to another address space. There may also be consistency guarantees that depend on the identity of the data itself, with some data having different consistency than others. The consistency status may also change based on type of data.

The consistency capability status may also identify one or more types of snapshots that the storage entity supports. For instance, the consistency capability status might indicate a frequency of snapshot, whether an entire image of the storage entity is snapshotted, or whether just user data is snapshotted, and so forth.

The consistency capability status might also indicate whether or not the storage entity supports preconditioning for use so as to allow the software module to instruct that the storage entity be placed in a particular condition. For instance, the software module might instruct that the storage entity be placed in a particular initial state based on a precondition image. The precondition image might include a particular file system and files.

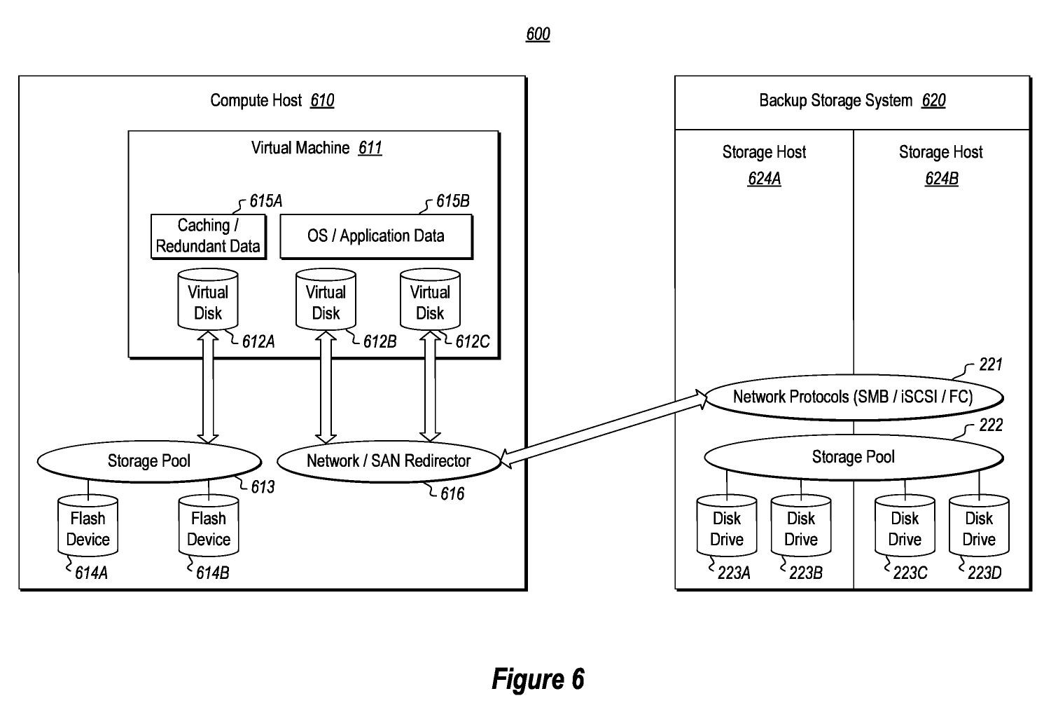

In one embodiment, the environment 200 is employed in a network environment, such as a cloud computing environment that is described further below. In that context, the software module 201 may be a virtual machine or hypervisor, whilst the storage entities 210 may be virtual storage entities, such as a virtual hard drive. More regarding an example cloud computing environment will be described with respect to FIG. 6.

The storage entities 210 are illustrated as including storage entity set 211 and storage entity set 212. The storage entity set 211 includes a storage entity 211A having a first consistency capability status 221. However, the ellipses 211B represent that there may be one or more additional storage entities that also have the first consistency capability status 221. The storage entity set 212 includes a storage entity 212A that has a second consistency capability status 222 that is different than the first consistency capability status 221. However, the ellipses 212B represent that there may be one or more additional storage entities that also have the first consistency capability status 221. Furthermore, the ellipses 213 represent that there may be one or more additional storage entity sets that have yet other consistency capability statuses. Furthermore, as represented by ellipses 203, there may be additional software modules that communicate with the storage entities 210 via the application program interface 205.

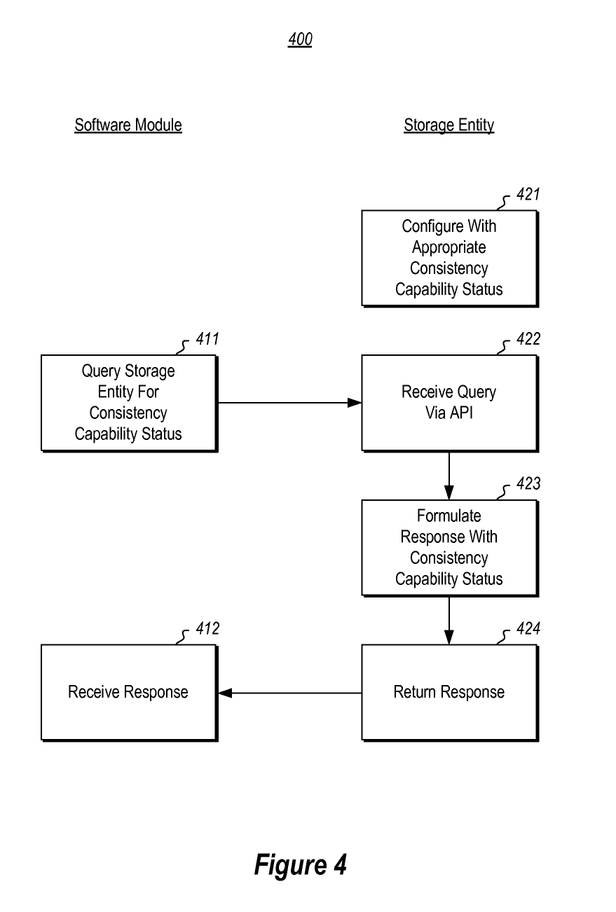

FIG. 3 illustrates a flowchart of a method 300 for configuring a software module to have access to storage entities having various consistency capability statuses. The method 300 includes coupling a software module with a first set of one or more storage entities having a first consistency capability status via an application program interface (act 301). The method 300 also includes coupling the software module with a second set of one or more storage entities having a second consistency capability status that is different than the first consistency capability status (act 302). The ellipses 303 represents that the software module may be coupled to yet other storage entities having one or more other consistency capability status. As there is no temporal dependence regarding when the first and second sets of storage entities are configured, acts 301 and 302 are illustrated as isolated blocks. As will be described below with respect to FIG. 4, the software module is configured to discover the various consistency capability statuses via the application program interface 205.

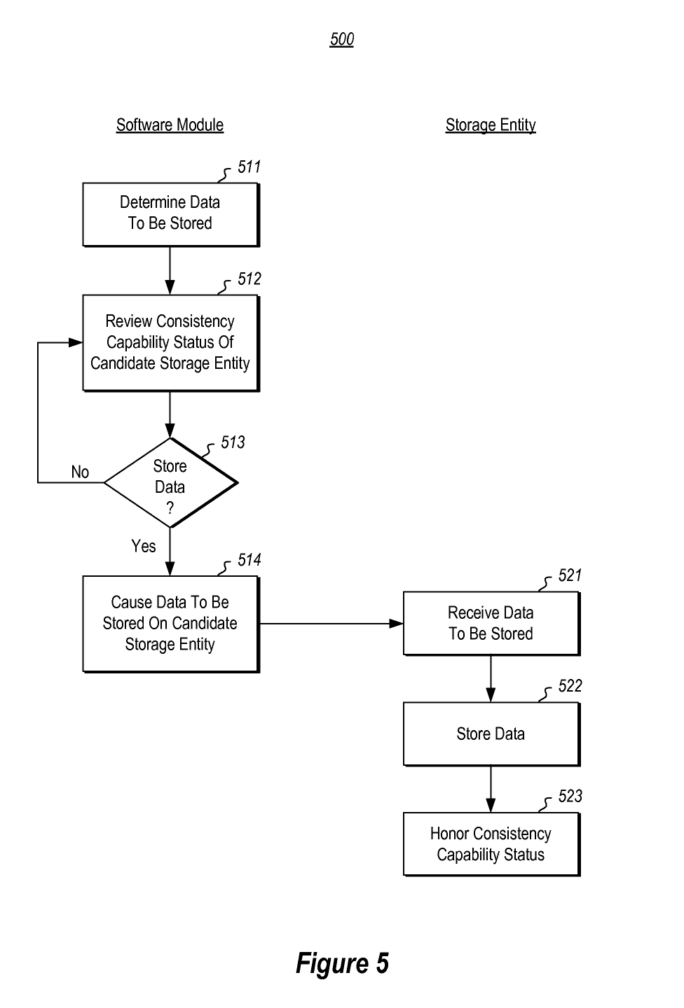

FIG. 4 illustrates a flowchart of a method 400 for enabling a storage entity to expose technical capabilities of the storage entity. For instance, the method 400 may be used to expose a consistency capability state of a storage entity. Once the consistency capability status is exposed, the software module may use the consistency capability status to determine whether to store particular data in the storage entity. Accordingly, FIG. 5 illustrates a flowchart of a method 500 for the software entity to store data in the storage entity. As the method 400 of FIG. 4 and the method 500 of FIG. 5 may be performed within the environment 200 of FIG. 2, FIG. 4 will now be described with frequent reference to FIG. 2. Thereafter, FIG. 5 will be described with frequent reference to FIG. 2. In both the method 400 of FIG. 4, and the method 500 of FIG. 5, acts performed by the software module 201 will be described in the left column under the heading “Software Module” and will be labelled in the 410s (for FIG. 4) or 510s (for FIG. 5). Likewise, acts performed by the storage entity 210 will be described in the right column under the heading “Storage Entity” and will be labelled in the 420s (for FIG. 4) or 520s (for FIG. 5).

Referring to FIG. 4, the storage entity is first configured with an appropriate consistency capability status (act 421). This may be performed as a function of the underlying consistency provided by the physical storage device(s) that support the storage entity. For instance, if the storage entity is supported by a local flash storage/memory device, then perhaps there is no consistency capability guarantee at all. Thus, any storage entity supported by the flash storage/memory device(s) might have a consistency capability status (i.e., “no caching”) reflecting an absence in consistency capability. Alternatively, a storage entity may be configured with any of the other consistency capability statuses mentioned above. The configuration of the storage entity may be performed in advance of the remainder of the method 400—even perhaps well prior to the performance of method 300. The act 421 is performed each time the consistency capability status changes.

The storage entity is queried through an application program interface to determine the technical capabilities of the storage entity (act 411). For instance, in FIG. 2, the storage entity 210 is queried via the application program interface 205 for the technical capabilities of one or more of the storage entities 210. As an example, suppose that the technical capabilities of the storage entity 211A are queried. This query may originate from the software module 201 although that is not required. While the storage entity is only configured in act 421 each time the consistency capability status is established or changed, the querying for such status (act 411) may occur any time the status is needed.

The storage entity receives the request for the technical capabilities via the application program interface (act 422). For instance, in FIG. 2, following the previous example, the storage entity 211A receives the query from the software module 201 via the application program interface 205.

In response to the query, a response is formulated that includes a consistency capability status of the storage entity (act 423). As an example, in FIG. 2, a response is formulated that includes the consistency capability status 211A of the storage entity 202A. In one embodiment, the storage entity 202A may itself formulate this response.

The storage entity then provides the formulated response with the consistency capability status to the software module via the application program interface (act 424). For instance, in FIG. 2, the storage entity 211A returns a response via the application program interface 205 to the software module 201, the response including the consistency capability status 221.

The software module then receives the response from the storage entity through the application program interface (act 412), the response indicating the consistency capability status. In some embodiments described herein, in addition to the consistency capability status, the response may also indicate an ability to precondition the storage entity for use. In that case, the software module causes the storage entity to be preconditioned for use. For instance, this might be accomplished by the software module 201 using the application program interface 205 to instruct the storage entity 211A to take upon itself a predetermined initial condition for use. This instruction might include a preconditioning image that is applied to the storage entity. Accordingly, the storage entity 211A may be preconditioned to take upon a certain directory structure, file system, and files.

The method 400 may be performed any number of times such that the software module learns the consistency capability status of each of the storage entities. For instance, in FIG. 2, the software module 201 may use the method 400 to learn the consistency capability status 220 of each of the storage entities 210. If the consistency capability status of the storage entities were to change, the method 400 may be repeated even for a given storage entity, to thereby track the changing consistency capability status. Thus, the software module 201 may understand that it has available to it a number of storage entities that collectively offer a number of consistency capabilities statuses.

Referring to the method 500 of FIG. 4, the software module first determines that data should be stored (act 511). For instance, in FIG. 2, the software module 201 determines that particular data is to be stored.

The software module also reviews the consistency capability status of a candidate storage entity to store the data on (act 512). As an example, in FIG. 2, the software module 201 may review the consistency capability status 221 received in performing the method 400 with respect to the storage entity 211A. This review (act 512) may be performed before, during, and/or after the software module determines that data is to be stored (act 511).

In response to the act of determining that data is to be stored (act 511), and the act of reviewing the consistency capability status (act 512), the software module decides whether store the data on the storage entity (decision block 513) given that consistency capability status. For instance, in FIG. 2, the software module 201 may decide whether to store the particular data on the storage entity 211A using the consistency capability status 221.

If the software module determines not to store the particular data on that storage entity (“No” in decision block 513), then the method 500 may return to act 512 to review the consistency capability status of another candidate storage device. However, the software module may be designed such that the software module decides to store the data on one of the available storage entities (“Yes” in decision block 513). Accordingly, the data is stored somewhere.

In response to the act of deciding to store the data on the storage entity (“Yes” in decision block 513), the software module then causes the particular data to be stored on the storage entity (act 514). Thus, in the example that references FIG. 2, the software module 201 may issue a write instruction to the storage entity 211A via the application program interface 210.

In response, the storage entity receives data to be stored from the storage entity (act 521), and stores the received data on the storage entity (act 522). For instance, in FIG. 5, the storage entity 211A receives the data to be stored from the software module 201 via the application program interface 205, and thus stores the received data.

Furthermore, the storage entity honors the consistency capability status on the stored data (act 523). For instance, if the storage entity advertised a certain type of snapshotting, the storage entity ensures that this type of snapshotting is performed. If, by chance, the storage entity is no longer capable of providing the advertised consistency, the storage entity may make that known to any software module that requested the consistency status and thereafter stored data on the storage entity. This will give the software module an opportunity to decide if placement of certain data on the storage entity is still appropriate and if not, to move the data.

As previously mentioned, in one embodiment, the software module 201 is a virtual machine, and the storage entities 210 are virtual drives that are of course backed by physical storage. FIG. 6 illustrates a specific example environment 600 that represents an example of the environment 200 of FIG. 2. The environment 600 includes a compute host 610 and a backup storage system 620.

The compute host 610 has running thereon a virtual machine 611, which is an example of the software module 201 of FIG. 1. The virtual machine 611 is associated with a virtual disk 612A (representing an example of the storage entity 211A of FIG. 2). The virtual disk 612A is backed by a storage pool 613 containing flash devices 614A and 614B. The flash devices 614A and 614B do not themselves provide any sort of consistency guarantee—and thus neither does the virtual disk 612A. Accordingly, the virtual machine 611 elects to store only caching or redundant data 615A to the virtual disk 612A.

The virtual machine is also associated with virtual disks 612B and 612C, which are backed by a redirector 616 (e.g., a network and/or Storage Area Network (SAN) redirector) that redundantly backs up data to the backup storage system 620. Because of the greater consistency guarantees of the virtual disks 612B and 612C, the virtual machine 611 chooses to store more consistency-sensitive operation system and application data 615B to those virtual disks 612B and 612C. The virtual disks 612B and 612C are examples of the storage entities 212 of FIG. 2.

The backup storage system 620 may be, for example, a file server cluster and/or a redundant SAN. The backup storage system 620 provides consistency for the virtual disks 612B and 612C by receiving and storing the data received via network protocols 621 to the backup storage pool 622. The backup storage pool 622 provides redundant storage for each of the virtual disks 612B and 612C since the backup storage pool 622 is supported by physical disk drives 623A through 623D on different storage hosts 624A and 624B.

In one embodiment, extensions of the T10 protocol are used in order to implement the application program interface 205. For instance, the virtual disks 612A, 612B and 612C may advertise their consistency capability status in the form of Vital Product Data. Alternatively or in addition, the advertisement might take the form of a Mode Select command where an attempt to turn off internal caches fails. Alternative or in addition, the device may be marked as a “Solid State Disk” (SSD) where the expectation is that the software module will know that SSDs are intended to be used as volatile caches. However, the principles described herein are not limited to how the application program interface 205 is implemented. It may be, for instance, an extension of the NVMe interface, or perhaps but a custom interface altogether of its own right.

Migration and failover of a virtual disk that does not provide full consistency guarantees will now be described. Several migration strategies are described herein, each applicable to different environments.

One migration strategy is to configure each host that contains local physical storage that does not contain consistency guarantees (e.g., local flash devices) with a resource pool that points to that local flash. When the virtual machine migrates, the virtual hard drive that is backed by the physical storage undergoes storage migration to the new host, to whatever namespace is pointed to by the resource pool. The advantage of this approach is that the data is preserved and the application is uninterrupted. The disadvantage is that the data has to be copied over and the network and performance of the virtual hard drive not providing consistency guarantees is low during migration.

A second migration strategy is to remove the virtual disk from the virtual machine cleanly, with application cooperation. A new virtual disk is created on the new host and inserted live, into the virtual machine. The advantage of this approach is that nothing is copied. The disadvantage is that the application has to understand that it needs to reconfigure itself to make certain behaviors after receiving external events.

A third migration strategy is that when the virtual machine is configured, the virtual hard drive not providing consistency guarantees is placed on storage entity set 212 and/or redirector 616. After the virtual machine user formats the virtual hard drive and creates whatever directory structure it likes, it marks the disk as “prepared” by perhaps sending a custom SCSI command. At this point, a hypervisor creates a virtual disk snapshot, including a new differencing virtual hard drive, which is then stored on local flash on the compute host. The differencing virtual hard drive points to the parent, on cluster storage. The application then runs until the virtual machine is migrated. Either the virtual disk is surprise-removed or the application is notified. When the migration is complete, the new hypervisor host creates a new differencing virtual hard drive on local flash, pointing to the original parent virtual hard drive on cluster storage. The state of the virtual disk is then reset to the point where the app identified it as prepared. Lastly, the virtual disk is resurfaced within the virtual machine. Failover is a little different, but mostly in that it does not require application notification, since the application crashes along with the physical host.

Some aspects described herein may be performed in a cloud computing environment. For instance, the environment 600 of FIG. 6 may be implemented completely in a cloud computing environment in, for instance, one or more data centers. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Accordingly, herein described is an effective mechanism to configure and utilize storage entities of a variety of consistency capabilities statuses, even for use in virtual machines. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for enabling a storage entity to expose technical capabilities of the storage entity, the method comprising:
querying the storage entity through an application program interface to determine technical capabilities of the storage entity;
receiving a response from the storage entity through the application program interface indicating a consistency capability status;
determining that data should be stored;
reviewing the consistency capability status in response to the determination;
as a result of the review, deciding-to store storing the data on the storage entity; and
in response to the decision, causing the data to be stored on the storage entity.

2. The method in accordance with claim 1, the storage entity being block-based storage.

3. The method in accordance with claim 1, the storage entity being file-based storage.

4. The method in accordance with claim 1, the storage entity being a database.

5. The method in accordance with claim 1, the storage entity being blob storage.

6. The method in accordance with claim 1, wherein there is a plurality of valid consistency capability statuses.

7. The method in accordance with claim 6, one of the plurality of valid consistency capability statuses being that there is no consistency guarantee for the storage entity.

8. The method in accordance with claim 6, one of the plurality of valid consistency capability statuses being that there is a limited consistency guarantee for the storage entity.

9. The method in accordance with claim 1, the consistency capability status indicating a type of snapshot that that storage entity supports.

10. The method in accordance with claim 1, the response from the storage entity also indicating an ability to precondition the storage entity for use.

11. The method in accordance with claim 10, further comprising:
causing the storage entity to be preconditioned for use.

12. The method in accordance with claim 11, wherein causing the storage entity to be preconditioned for use comprises applying a preconditioning image to the storage entity.

13. The method in accordance with claim 1, the software entity being a virtual machine, the storage entity being a virtual storage entity.

14. The method in accordance with claim 13, further comprising migrating the virtual machine.

15. The method in accordance with claim 13, further comprising performing failover for the virtual machine.

16. A method for a storage entity to expose technical capabilities of the storage entity, the method comprising:
receiving a query for technical capabilities from a device;
in response to the receiving the query, formulating a response that includes a consistency capability status;
providing the formulated response with consistency capability status to the device so that the device may determine whether to store data on the storage entity;
receiving data to be stored from the device after providing the formulated response;
storing the received data on the storage entity; and
honoring the consistency capability status on the stored data.

17. The method in accordance with claim 16, the storage entity being a virtual hard drive.

18. The method in accordance with claim 16, wherein the hosts a virtual machine.

19. The method in accordance with claim 16, wherein the device hosts a hypervisor.

20. A computer program product comprising one or more computer-readable storage media having thereon computer-executable instructions that are structured such that, when executed by one or more processors of a computing system, cause the computing system to perform a method for configuring a software module to have access to storage entities having various consistency capability statuses, the method comprising:
coupling the software module with a first set of one or more storage entities having a first consistency capability status via an application program interface, the software module configured to discover the first consistency capability status via the application program interface; and
coupling the software module with a second set of one or more storage entities having a second consistency capability status that is different than the first consistency capability status, the software module configured to discover the second consistency capability status via the application program interface,
the software module having a decision module that considers consistency capability status in deciding which data to store on storage entities.
